(19) United States
(12) Patent Application Publication
(10) Pub. No.: US 2008/0048108 A1
(43) Pub. Date: Feb. 28, 2008

(54) BAFFLE APPARATUS AND SYSTEMS AND METHODS USING THEM

(76) Inventor: David Alan Barkus, Oakville, CT (US)

Correspondence Address: LOWRIE, LANDO & ANASTASI, LLP;P2021, ONE MAIN STREET, SUITE 1100, CAMBRIDGE, MA, 02142, US

(21) Appl. No.: 11/844,501

(22) Filed: Aug. 24, 2007

Related U.S. Application Data
(60) Provisional application No. 60/823,569, filed on Aug. 25, 2006.

(51) Int. Cl. B01D 59/44

(52) U.S. Cl. 250/282; 417/151

(57) ABSTRACT

A baffle comprising a plurality of apertures wherein at least one of the plurality of apertures comprises a convergent portion and a divergent portion is provided. In some examples, a baffle comprising at least two concentric cones may be used. In other examples, the baffle may be used in an oil diffusion pump for use in an analytical device, such as a mass spectrometer.

### PRIORITY APPLICATION

This application claims priority to U.S. Provisional Application No. 60/823,569 filed on Aug. 25, 2006, the entire disclosure of which is hereby incorporated herein by reference for all purposes.

### TECHNOLOGICAL FIELD

Examples disclosed herein relate generally to devices and methods for use in diffusion pumps. More particularly, certain embodiments disclosed herein relate to devices that may be used in an oil diffusion pump for use in a mass spectrometer.

### BACKGROUND

Simple baffles are often inefficient in use of space for funneling gas into an oil diffusion pump and blocking oil vapor from exiting the pump. Common designs are comprised of offset, overlapping plates or surfaces, or chevron slots to achieve optical density. Further, many existing baffles rely on a cooled volume with an optically dense path of exit for oil vapor and aerosol. Such designs often require significant space, assembly, and cost.

### SUMMARY

In accordance with a first aspect, an oil diffusion pump comprising a jet assembly, a heating element, a chamber and a baffle is provided. In certain examples, the baffle may be a non-cooled baffle that is fluidically coupled to the chamber and comprises a plurality of apertures, wherein at least one of the plurality of apertures comprises a convergent portion and a divergent portion.

In some examples, the baffle may be constructed and arranged with a symmetric number of apertures about a central axis of the baffle. In other examples, the baffle may be constructed and arranged with asymmetric number of apertures about a central axis of the baffle. In additional examples, the oil diffusion pump may further comprise an additional pump fluidically coupled to the diffusion pump. In certain examples, the baffle may further comprise a circumferential ridge. In other examples, the baffle may comprise at least two concentric cones and the apertures may be positioned between the at least two concentric cones. In some examples, the baffle may further comprise at least one rib configured to connect the at least two concentric cones.

In accordance with another aspect, an oil diffusion pump comprising a jet assembly, a heating element, a chamber and a non-cooled baffle fluidically coupled to the chamber and comprising at least two concentric cones is disclosed. In some examples, the baffle may comprise two to five concentric cones. In other examples, the pump may further comprise an additional pump fluidically coupled to the oil diffusion pump. In some examples, the baffle may comprise a circumferential ridge. In certain examples, the baffle may include an aperture positioned between the at least two concentric cones.

In accordance with an additional aspect, a mass spectrometer comprising a mass analyzer, a detector fluidically coupled to the mass analyzer, and an oil diffusion pump fluidically coupled to the mass analyzer and the detector is provided. In certain examples, the oil diffusion pump of the mass spectrometer comprises a jet assembly comprising a plurality of nozzles, a heating element, a chamber configured to receive an oil and coupled to the heating element and the jet assembly, and a non-cooled baffle fluidically coupled to the chamber and comprising a plurality of apertures, wherein at least one of the plurality of apertures comprises a convergent portion and a divergent portion.

In certain examples, the baffle of the mass spectrometer includes at least two concentric cones and apertures are positioned between the at least two concentric cones. In some examples, the baffle may comprise at least one rib connecting the concentric cones. In certain examples, the mass spectrometer further comprises a sample introduction device fluidically coupled to the mass analyzer. In other examples, the mass spectrometer further comprises a gas chromatography system fluidically coupled to the sample introduction device. In additional examples, the oil diffusion pump may be mounted proximate to the mass analyzer of the mass spectrometer.

In accordance with another aspect, a mass spectrometer comprising a mass analyzer, a detector fluidically coupled to the mass analyzer, and an oil diffusion pump fluidically coupled to the mass analyzer and the detector is disclosed. In certain examples, the oil diffusion pump comprises a jet assembly comprising a plurality of nozzles, a heating element, a chamber configured to receive an oil and coupled to the heating element and the jet assembly, and a non-cooled baffle fluidically coupled to the chamber and comprising at least two concentric cones. In some examples, the baffle may include an aperture positioned between the at least two concentric cones. In certain examples, the baffle may further comprise at least one rib configured to connect the concentric cones. In some examples, the mass spectrometer may further comprise a sample introduction device fluidically coupled to the mass analyzer. In other examples, the mass spectrometer may further comprise a gas chromatography system fluidically coupled to the sample introduction device. In certain examples, the oil diffusion pump may be mounted proximate to the mass analyzer of the mass spectrometer

In accordance with an additional aspect, a method of configuring a mass spectrometer is provided. In certain examples, the method comprises mounting an oil diffusion pump proximate to a sample introduction device, and configuring the oil diffusion pump with a non-cooled baffle including at least one aperture comprising a convergent portion and a divergent portion, wherein the baffle is constructed and arranged to retard loss of oil vapor from the oil diffusion pump. In some examples, the method may further comprise configuring the baffle with a plurality of apertures, wherein each aperture comprises a convergent portion and a divergent portion.

In accordance with another aspect, a method of configuring a mass spectrometer comprising mounting an oil diffusion pump proximate to a sample introduction device, and configuring the oil diffusion pump with a non-cooled baffle comprising at least two concentric cones, wherein the baffle is constructed and arranged to retard loss of oil vapor from the oil diffusion pump is disclosed. In some examples, the method may further comprise configuring the baffle with at least one aperture positioned between the concentric cones.

Additional aspects, examples, embodiments and features will be recognized by the person of ordinary skill in the art, given the benefit of the instant specification.

### BRIEF DESCRIPTION OF THE FIGURES

Certain embodiments are described in more detail below with reference to the figures in which:

FIG. 1 is a schematic of an oil diffusion pump, in accordance with certain examples;

FIGS. 2A and 2B are a top view and bottom view, respectively, of a baffle, in accordance with certain examples;

FIG. 3 is a cross-section of a baffle comprising an aperture with a convergent portion and a divergent portion, in accordance with certain examples;

FIGS. 4A-4D are cross-section showing various baffle shapes, in accordance with certain examples;

FIG. 5 is a cross-section showing an asymmetric baffle, in accordance with certain examples;

FIG. 6 is a cross-section showing a symmetric baffle that has been rendered asymmetric with a gasket, in accordance with certain examples;

FIG. 7 is a block diagram of a mass spectrometer, in accordance with certain examples; and

FIG. 8 is a cross-section of an assembled oil diffusion pump, in accordance with certain examples.

Unless otherwise clear from the context, the use of the terms “top” and “bottom” is arbitrary and for illustrative purposes only, and the devices disclosed herein may be used in any orientation. In addition, certain dimension, features, components and the like may have been enlarged, distorted or otherwise shown in a non-proportional or non-conventional manner to facilitate a better understanding of the technology disclosed herein.

### DETAILED DESCRIPTION

Certain features, aspects and examples of the technology disclosed herein provide significant advantages over existing systems including, but not limited to, improved gas flow, prevention of flow of oil particles into an instrument, improved detection limits and the like. Certain embodiments of the baffles disclosed herein may be used in a variety of systems having an oil diffusion pump, for example, an oil diffusion pump coupled to a mass spectrometer. Examples of the baffles disclosed herein may be constructed and arranged for use in any oil diffusion pump and provides for gas conductance more easily in one direction than the other. Certain embodiments of the baffles may also significantly reduce, and in some embodiments, prevent flow of oil vapor and particles in one direction. Some examples disclosed herein are directed to a non-cooled baffle. As used herein, “non-cooled baffle” refers to a baffle without active heat removal, e.g., through the use of a cooling fluid. In embodiments where the baffle is a non-cooled baffle, the baffle may have smaller dimensions than a cooled baffle, may decrease the mean free path and increase the likelihood of collisions of gas atoms and molecules with oil vapor and aerosol, may rest on the vacuum chamber without touching the mouth of the pump so heat is not transferred directly by conduction and may provide other advantages such as, for example, be optically dense to prevent a direct path (line of sight) for oil to pass through, provide a suitable surface area for oil vapor to condense, provide suitable surfaces for oil aerosols or particulates to collide and stick, provide a suitable geometry for oil to collect, drip and return to the diffusion pump

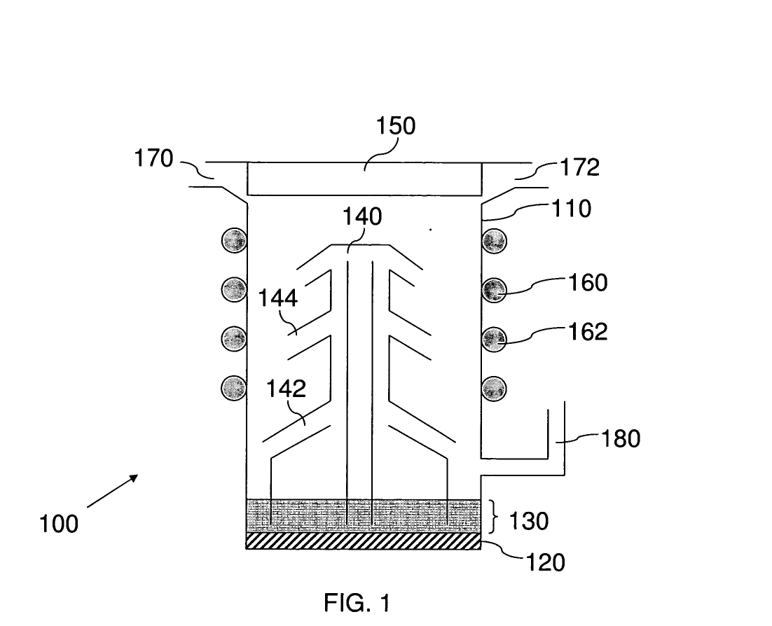

In accordance with certain examples, the baffles disclosed herein may be used in an oil diffusion pump. A simplified schematic of an oil diffusion pump that includes a baffle is shown in FIG. 1. The oil diffusion pump 100 comprises a housing 110 that includes a heating element 120, an area or a chamber 130 configured to receive an oil to be vaporized, a jet assembly, such as a multistage jet assembly 140, and a baffle 150, which is shown as a non-cooled baffle though a cooled baffle may be used in certain instances. The outer surface of the pump may be air or water cooled using, for example, a water jacket or water coils, such as water coils 160 and 162 shown in FIG. 1. During operation of the oil diffusion pump 100, the heating element 120 is operative to vaporize the oil. As the oil vapor travels upward in the jet assembly 140, the oil is jetted or shoots out through the various nozzles, e.g., concentric ring shape nozzles such as nozzles 142 and 144, of the jet assembly and condenses on the cool wall of the housing 110. As the vapor condenses, it entrains gas molecules entering the pump through one or more fluid inlets (e.g., gas or aerosol inlets), such as fluid inlets 170 and 172. The multistage jet assembly 140 is designed such that a pressure gradient is created as gaseous oil molecules pass through the jets at high velocity and condense on the walls of the housing 110. Oil vapor exiting from the uppermost nozzles is most susceptible to being “back-streamed” or undesirably introduced into a chamber, inlet or manifold that is mounted above the pump. The movement of the oil vapor generates high pressure near area 130 and lower pressure at the fluid inlets 170 and 172 which provides the pumping that reduces the pressure of a device or chamber (not shown) coupled to the fluid inlets 170 and 172. The entrained gases from the fluid inlets 170 and 172 flow toward the base of the pump 100 at increased pressure and are exhausted through outlet 180, which may be fluidically coupled to another pump, e.g., a fore pump.

In accordance with certain examples, the non-cooled baffle 150 may be constructed and arranged to prevent oil vapor from entering the device or chamber coupled to the fluid inlets 170 and 172, as discussed further below. By including a baffle in certain embodiments of an oil pump, the oil pump may be mounted proximate to a sample introduction device or sample inlet without allowing the oil to enter the detector or analyzer, e.g., the pump may be mounted within a few inches or directly fluidically coupled without any intervening devices. Such advantage may be particularly useful in mass spectrometry to reduce the overall footprint of the instrument. Also, by mounting the diffusion pump closer to the sample introduction device, enhanced fluidic coupling may be achieved to provide better fluid coupling between the pump and the device to which it is attached. This configuration may provide for increased removal of gases that may interfere with detection of species by an instrument and/or may reduce the rate of contamination of the instrument. Additional advantages of using the baffles disclosed herein will be recognized by the person of ordinary skill in the art, given the benefit of this disclosure.

In accordance with certain example, a non-cooled baffle comprising at least two concentric cones is disclosed. Concentric cones have an advantage of concentrating the fluids, e.g., gases, entering the pump. This concentrating effect increases the likelihood of entering molecules colliding with oil vapor traveling upstream. The effect also retards oil back-streaming through the baffle. Concentric cones also provide an efficient use of space which may reduce the overall size of the baffle. The concentric cones may include reversing angles and ribs to hold the cones together. This design may increase efficiency for gas conduction (low restriction and optimized use of space) into an oil diffusion pump. Embodiments of the baffle may be configured with converging surfaces to provide a funneling effect and diverging surfaces to provide a de-funneling effect. The design further increases the effectiveness for blocking and condensing oil vapor and aerosols exiting the oil diffusion pump. Because of the one piece design, the baffle may be produced from a single piece of, for example, metal, although other suitable materials can be used, and the baffle can be easily installed, removed, and cleaned. The desired baffle geometry may be achieved by lathe turning and milling and may be inherently stiff and stable due to the selected materials.

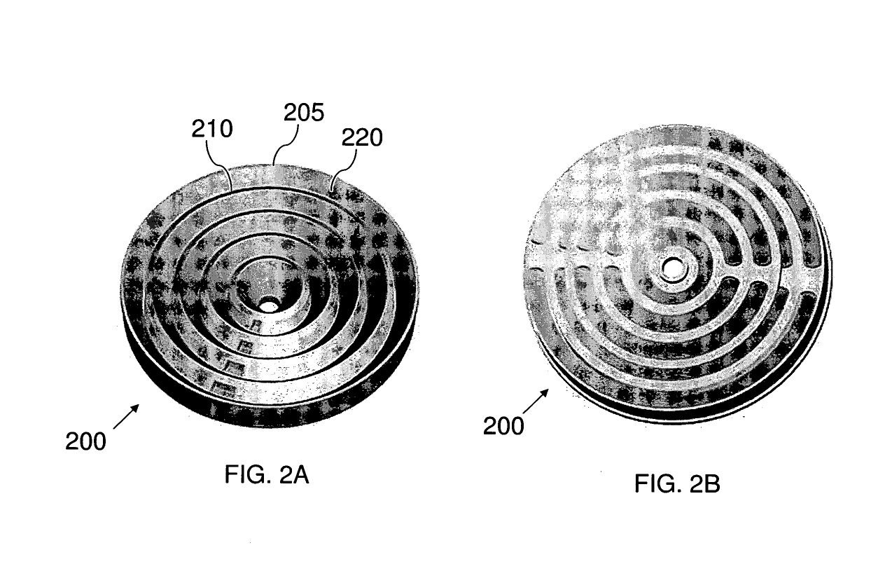

In certain examples, a schematic of a non-cooled baffle comprising concentric cones is shown in FIGS. 2A (top view) and 2B (bottom view). The baffle 200 comprises a plurality of concentric cones, such as cones 205 and 210, spaced apart by apertures, such as aperture 220. The exact design, number and shape of the concentric cones and the apertures may vary depending on the intended use of the oil diffusion pump. In certain examples, the baffle includes about four to about twelve concentric cones, more particularly about five to about ten concentric cones, e.g., about six to about nine concentric cones. It will be recognized, by the person of ordinary skill in the art, given the benefit of this disclosure, that fewer or more concentric cones may be used as long as the baffle provides adequate fluid flow into the pump and prevents or retards loss of oil vapor from the pump.

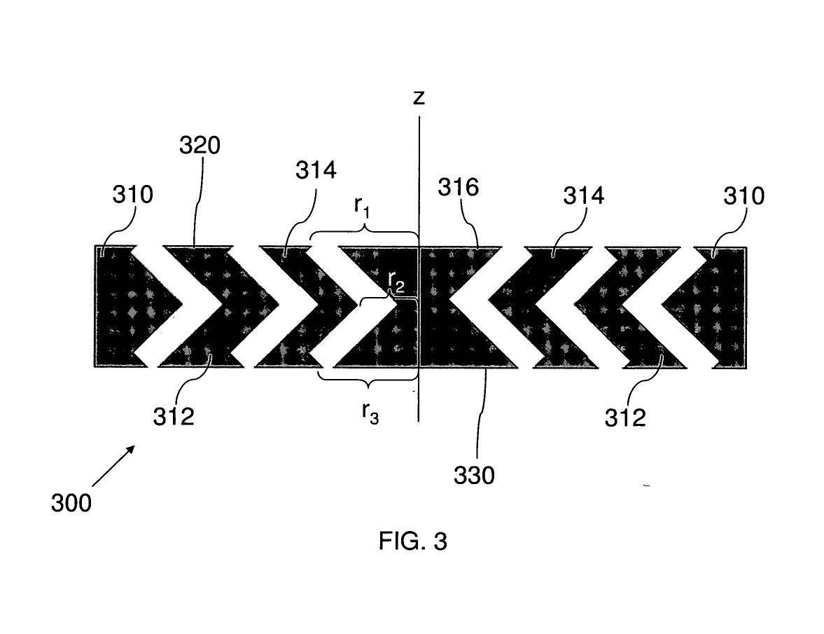

In certain examples, the number of apertures in the baffle may vary and are typically determined by the number of concentric cones that are present. The shape and geometry of the apertures may also be based, at least in part, on the shape and type of concentric cones used. Referring to FIG. 3, a cross-section of the apertures of a baffle 300 comprising four concentric cones 310, 312, 314 and 316 is shown. In baffle 300, the apertures are spaced symmetrically about a central axis (shown as the z-axis in FIG. 3) perpendicular to a radial axis of the baffle 300 with three apertures on each side of the central axis in the embodiment shown. From a top surface 320 of the baffle 300 to the center of the baffle 300, the apertures include a portion that angles toward the central axis of the baffle. This portion is referred to in certain instances herein as a “convergent portion.” About midway through the thickness of the baffle 300, e.g., the center of the baffle, the angle of the aperture changes such that it reverses or moves away from the central axis of the baffle. This portion is referred to in certain instances herein as a “divergent portion.” Thus, the radial distance from the center of the aperture decreases from a top surface to the middle of the baffle and then increases from the middle of the baffle toward the bottom surface of the baffle, e.g., r₁ is greater than r₂, and r₂ is less than r₃. This design permits fluid flow into the baffle while restricting oil vapor from escaping from the baffle. For example, the baffle may be placed at the top of a diffusion pump and fluidically coupled to a fluid inlet and the diffusion pump such that gas may enter the diffusion pump and become entrained in the jetted oil vapor while minimizing any back streaming of oil into the fluid inlet and/or out of the diffusion pump. While each of the apertures in baffle 300 are shown as including a convergent portion and a divergent portion, the baffle may be constructed and arranged such that only one or less than all apertures are configured with a convergent portion and a divergent portion.

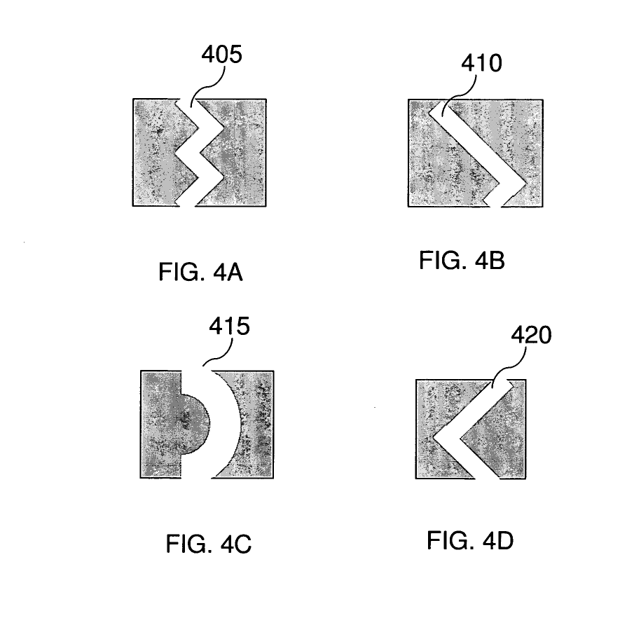

In accordance with certain examples, the exact cross-sectional shape of the apertures may vary and different designs may increase fluid flow into pump while reducing the likelihood of oil vapor escaping from the pump. The person of ordinary skill in the art, given the benefit of this disclosure, will recognize that any desired cross-sectional aperture shape may be used so long as a pressure differential is created and no substantial amounts of oil vapor exit the pump. In certain examples, the aperture may include a plurality of convergent and divergent portions as shown in the aperture 405 of FIG. 4A. In some examples, the aperture may be asymmetric with a longer portion above a radial axis than below a radial axis. An example of this type of aperture is shown as aperture 410 in FIG. 4B. In other examples, the aperture may be configured with round elbows or bends such that a lower resistance to gas flow is provided. An example of an aperture with a rounded elbow is shown as aperture 415 in FIG. 4C. In some examples, the aperture may first be divergent and the convergent (from a top surface to a bottom surface), as shown in aperture 420 of FIG. 4D. Such aperture shapes may be selected, for example, by selecting a particular design for the cones used in the baffle with the apertures being created by spaces between adjacent cones. Ribs or the like may be used to hold the cones together. In addition, the shape of the cones may be asymmetric such that different aperture shapes are present at different areas of the baffle. Other configurations of apertures will be readily selected by the person of ordinary skill in the art, given the benefit of this disclosure.

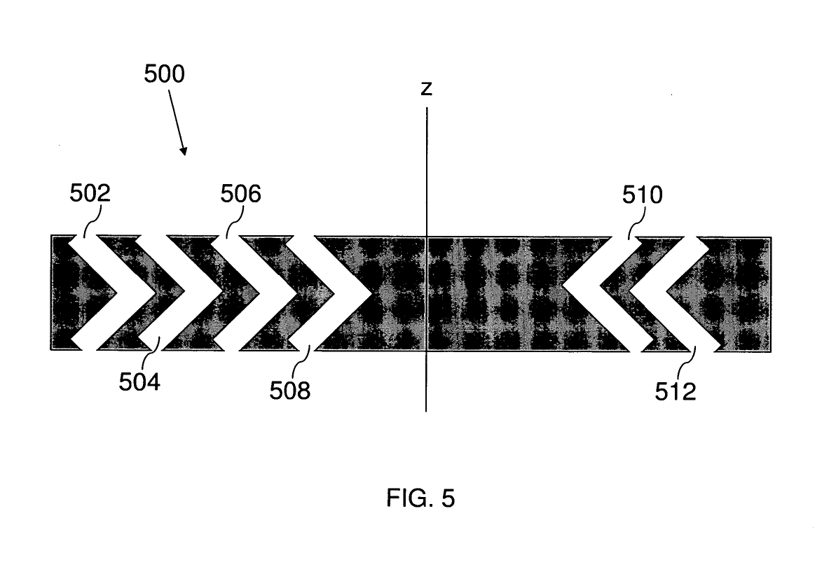

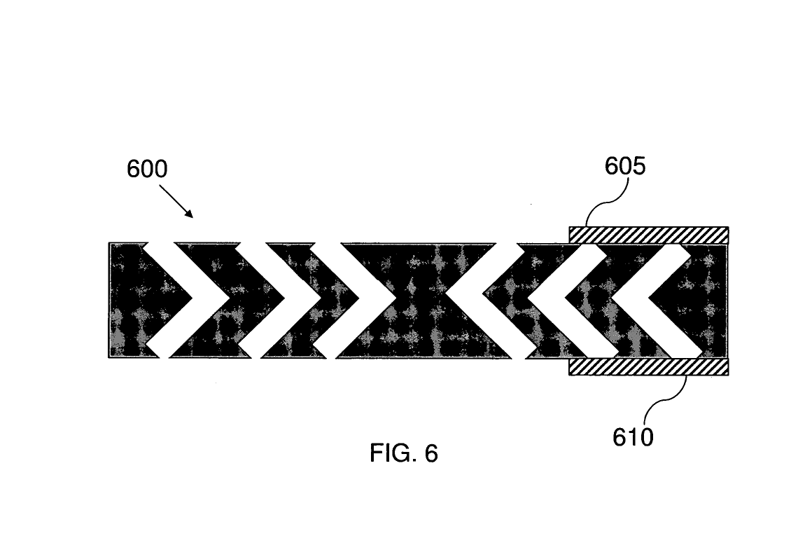

In accordance with certain examples, the baffles disclosed herein may be designed such that the apertures are arranged symmetrically about a central axis (FIG. 3) or such that the apertures are arranged asymmetrically about a central axis. For example and referring to FIG. 5, a baffle 500 comprises apertures 502, 504, 506, and 508 on a left side of the baffle 500 and apertures 510 and 512 on the right side of the baffle 500. It may be desirable to use an asymmetric baffle, for example, where there is more fluid flow toward one end of the baffle than the other. For example, where there is a higher gas flow on the left side of the baffle than the right side of the baffle, it may be desirable to use an asymmetric baffle with increased amounts of apertures on the left side. Such a configuration permits pulling of a larger volume of fluid from the left side than the right side. Asymmetric baffles may be produced, for example, by using asymmetric cones, by filling in the spaces between the concentric cones with structural materials such as metal or the like, or may be produced by capping off selected apertures using a lid, gasket or the like. An example of a symmetric baffle 600 that has been rendered asymmetric using a metal gasket 605 is shown in FIG. 6. A second metal gasket 610 may also be used to seal off selected apertures on one side of the baffle 600, though in certain examples, it may be desirable to omit gasket 610 such that oil vapor may enter the aperture and condense. In embodiments where a gasket is used to create an asymmetric baffle, a high temperature sealant or comparable material may be placed between the gasket and the baffle surface to provide a fluid tight seal that prevents or retards escape of any oil from around the gasket. While the baffles shown in FIGS. 5 and 6 are configured as including apertures that are convergent then divergent (from top to bottom), other aperture shapes and designs of an asymmetric baffle, either cooled or non-cooled, will be readily selected by the person of ordinary skill in the art, given the benefit of this disclosure.

In accordance with certain examples, the cooled baffles disclosed herein may include an inlet and an outlet for circulating a cooling fluid within the baffle. Cooling of the baffle may be desirable, for example, to condense oil vapor on the baffle surface to prevent the oil vapor from back-streaming. In some examples, the cooling fluid may be water, water including an additive, e.g., salts, ethylene glycol, etc., to raise the boiling point of the water, or some other fluid whose vaporization temperature is above the operating temperature of the diffusion pump. In some examples, the temperature of the cooling fluid may be selected such that the oil vapor condenses but the fluid entering into the pump from the fluid inlets does not condense to any substantial degree. Condensation of the gas may result in contamination of the pump oil and/or poor pump performance requiring frequent changing of the pump oil.

In accordance with certain examples, the exact dimensions of the baffles disclosed herein may vary depending in the size of the pump, pump housing, desired flow rate, desired vacuum and the like. In some examples, the baffle is generally circular (when viewed from the top or bottom) and has a diameter of about 3-6 inches, more particularly about 3-5 inches, e.g., about 4 inches. In certain examples, the top-to-bottom thickness of the baffle may be about 0.25 to about 2 inches, more particularly about 0.5 inches to about 1.5 inches, e.g., about 0.75 inches. In embodiments where the baffle is cooled, it may be desirable to increase the overall dimensions to provide inlets and/or outlets for a cooling fluid.

In accordance with certain examples, the exact material used to produce the baffles may vary, and the selected material may be any material that can withstand the high temperatures and pressures in the pump housing without any substantial adverse affects on pump performance. In some examples, the baffle may include a metal, a high temperature polymer or combinations thereof. In certain examples, the materials used in the baffle desirably do not substantially out gas or release any particulate or gaseous matter that may adversely affect a device to which the pump is providing a vacuum, e.g., to a mass spectrometer, electron microscope, semi-conductor processing equipment, etc. In some examples, the baffle may be made from stainless steel or other generally inert materials to retard or reduce corrosion in the baffle.

In accordance with certain examples, the baffles disclosed herein may include one or more indicia that assist in mounting of the baffle into the pump. Such indicia may include arrows, text, or structural features. For example, a circumferential ridge may be included such that the baffle may only be mounted correctly in one orientation in the pump. Circumferential grooves that are parallel to the central axis of the baffle may be included such that the grooves mate with a mounting member in the pump. Such grooves may be angled suitably to assist in mounting of the baffle into the pump, e.g., the grooves may be angled such that the baffle only mounts in a single orientation in the pump.

In accordance with certain examples, the baffles disclosed herein may include shapes other than concentric cones. In particular, certain embodiments may include apertures with convergent and divergent portions that have been machined or drilled into a solid metal disk. Other embodiments include apertures that have been etched into or otherwise produced from a body. Some examples include joining of two or more pieces or portions together to provide a unitary body having a desired shape and/or desired aperture spacing and arrangement. Additional configurations for producing baffles suitable for use in a diffusion pump will be readily selected by the person of ordinary skill in the art, given the benefit of this disclosure.

In certain examples, the diffusion pumps disclosed herein may be coupled to one or more additional pumps, e.g., mechanical pumps, fore pumps, turbomolecular pumps and the like. For example, a simple mechanical pump may be used to remove the bulk of the gas from the vacuum chamber of the diffusion pump. The diffusion pump may be operative to provide further gas removal to lower the pressure, which results in pulling of a vacuum. Suitable pumps include, but are not limited to, rotary pumps, oil-less (dry) pumps, scroll pumps, molecular drag pumps, diaphragm pumps and the like. Additional suitable pumps will be readily selected by the person of ordinary skill in the art, given the benefit of this disclosure.

In accordance with certain examples, the baffles disclosed herein may include one or more overlapping plates or surfaces, or chevron slots to achieve optical density, in addition to the concentric cones or other geometric structures used in the baffle. Such plates and chevrons may provide for further tuning of the fluid flow into the pump and the further retarding of oil vapor exiting the pump.

In accordance with certain examples, the oil diffusion pumps disclosed herein that include a baffle, e.g., a cooled or non-cooled baffle, may provide a vacuum down to a pressure of about 1×10⁻⁶ Torr to about 4×10⁻⁷ Torr or lower. In embodiments where the oil diffusion pump is used in a mass spectrometer, the oil diffusion pump may provide a vacuum at a pressure of about 3×10⁻⁵ Torr to about 1×10⁻⁵ Torr or lower. Additional suitable pressures are possible using the oil diffusion pumps disclosed herein.

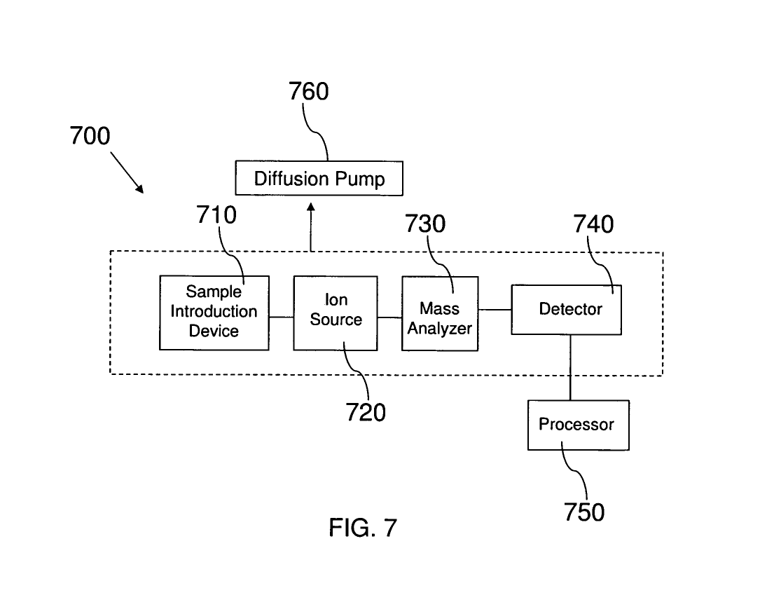

In accordance with certain examples, the baffles disclosed herein may be used in an oil diffusion pump coupled to a mass spectrometer. A schematic of a mass spectrometer (MS) is shown in FIG. 7. The mass spectrometer 700 comprises a sample introduction device 710, an ion source 720, a mass analyzer 730, a detector 740, a processor 750, and a diffusion pump 760. The diffusion pump 760, which includes one of the baffles (cooled or non-cooled) disclosed herein, is operative to provide a vacuum for the sample introduction device 710, the ion source 720, the mass analyzer 730, and the detector 740 such that the system is operated at reduced pressures. In certain examples, however, only the mass analyzer 730 and the detector 740 may be operated at reduced pressures. In certain examples, the sample introduction device 710 may include a batch type inlet, a direct probe inlet, or in the case where the mass spectrometer is coupled to chromatography system, a chromatographic inlet, e.g., one that includes a jet separator. The sample introduction device 720 may include an injector, a nebulizer or other suitable devices that may introduce a sample into the system.

In accordance with certain examples, the mass analyzer 730 may take numerous forms depending generally on the sample nature, desired resolution, etc. and illustrative mass analyzers are listed below. The detector 740 may be any suitable detection device that may be used with existing mass spectrometers, e.g., electron multipliers, photomultipliers, Faraday cups, coated photographic plates, ion traps, scintillation detectors, etc., and other suitable devices that will be selected by the person of ordinary skill in the art, given the benefit of this disclosure. The processor 750 typically includes a microprocessor and/or computer and suitable software for analysis of samples introduced into the MS 700. One or more databases may be accessed by the processor 750 for determination of the chemical identity of species introduced into MS 700. Other suitable additional devices known in the art may also be used with the MS 700 including, but not limited to, autosamplers, such as those used with TurboMatrix models commercially available from PerkinElmer, Inc. (Waltham, Mass.).

In accordance with certain examples, the mass analyzer of MS 700 may take numerous forms depending on the desired resolution and the nature of the introduced sample. In certain examples, the mass analyzer may be a scanning mass analyzer, a magnetic sector analyzer (e.g., for use in single and double-focusing MS devices), a quadrupole mass analyzer, an ion trap analyzer (e.g., cyclotrons, quadrupole ions traps), time-of-flight analyzers (e.g., matrix-assisted laser desorbed ionization time of flight analyzers), and other suitable mass analyzers that may separate species with different mass-to-charge ratios.

In accordance with certain other examples, the ion source may include a device to implement ionization methods commonly used in mass spectroscopy. For example, electron impact sources may be assembled to ionize species prior to entry of ions into the mass analyzer. In other examples, chemical ionization sources may be used to ionize species prior to entry of ions into the mass analyzer. In yet other examples, field ionization sources may be used to ionize species prior to entry of ions into the mass analyzer. In still other examples, desorption sources such as, for example, those sources configured for fast atom bombardment, field desorption, laser desorption, plasma desorption, thermal desorption, electrohydrodynamic ionization/desorption, etc. may be used. In yet other examples, thermospray ionization sources may be used. It will be within the ability of the person of ordinary skill in the art, given the benefit of this disclosure, to select suitable devices for ionization for use with the devices disclosed herein.

In accordance with certain examples, the MS may be coupled to a chromatography system, such as a gas chromatograph. A gas chromatograph generally includes a sample introduction device, an oven comprising a chromatography column, and one or more fluid flow paths connecting the sample introduction device and the chromatography column. The gas chromatograph is operative to separate species and pass those separated species to the MS for detection. In other examples, the MS may be coupled to a liquid chromatograph or a supercritical fluid chromatograph. Additional suitable devices for coupling to a MS will be readily selected by the person of ordinary skill in the art, given the benefit of this disclosure.

In accordance with certain examples, the MS may be coupled to another MS. The second MS may include a diffusion pump similar to the pump described herein or may include a turbomolecular pump or other suitable type of pump. The use of a diffusion pump in an MS system greatly reduces the overall cost. The second MS system with a turbomolecular pump may be configured as a second stage that can receive high flow rates, e.g., 250 L/second or more. The combination of a first stage having a diffusion pump and a second stage having a turbomolecular pump may reduce the overall system cost while providing for high overall flow rates. It will be recognized by the person of ordinary skill in the art, given the benefit of this disclosure, that the first and second stages may be inverted with the first MS stage including a turbomolecular pump and the second MS stage including a diffusion pump. In such configurations, it may be desirable to vent a portion of the gas stream to reduce the flow rate to an acceptable level for the second MS stage.

In accordance with certain examples, the pumps and MS systems disclosed herein are generally configured to be controlled using software that implements one or more algorithms. Suitable software is commercially available, for example, from PerkinElmer, Inc. (Waltham, Mass.) and includes the TurboMass™ GC/MS software available for use with the Clarus® 600 Mass Spectrometers. It will be within the ability of the person of ordinary skill in the art, given the benefit of this disclosure, to select other suitable algorithms for use with the devices disclosed herein.

In accordance with certain examples, the sensitivity of mass spectrometers coupled to an oil diffusion pump as disclosed herein depends, at least in part, on the species to be detected, the type of detector used, etc. Using photomultipliers, it may be possible to detect, for example, about 1 picogram of octafluoronaphthalene at a signal-to-noise ratio of 30:1. It is a significant advantage that such low detection limits may be achieved by mass spectrometers including low cost oil diffusion pumps that include a baffle as described herein.

In accordance with certain examples, the devices disclosed herein may be used to provide a vacuum to optical instruments. For example, vacuum circular dichroism, vacuum ultraviolet, X-ray spectroscopy or other optical techniques where oxygen or air may absorb the light use a vacuum to purge the sample chamber of any air or oxygen. The oil diffusion pumps disclosed herein may be used in such analytical devices to provide a vacuum for measurement of optical absorption, optical emission, or both, at low cost and without any substantial contamination from back-streaming.

In accordance with certain examples, the baffles disclosed herein may be used in an oil diffusion pump coupled to an electron microscope. In certain examples, the electron microscope comprises an electron beam or electron source, a sample holder, one or more condensers, an objective, and a collector screen. In a transmission electron microscope, electrons are generated as a cathode is heated by application of a current. The electrons travel toward a high voltage at the anode. The acceleration voltage is typically between 50 and 150 kV. The higher the voltage difference, the shorter are the electron waves, which increases the resolution of the microscope. The accelerated electron beams passes through an aperture at the bottom of the anode. The microscope typically includes a lens-system that consists of electronic coils generating an electromagnetic field. The electron beam is first focused by a condenser, and the passes through the sample where some of the electrons are deflected. The degree of deflection depends on the mass-to-charge ratio of the object. The greater the mass of the atoms, the greater is the degree of deflection. For atoms with low atomic numbers, it may be desirable to treat the sample with contrast enhancing chemicals (heavy metals) to get at least some contrast. After passing the sample, the scattered electrons are collected by an objective, and an image is formed. This image may be processed, digitally enhanced or enlarged using a second lens. The formed image may be viewed, for example, using a fluorescent screen or photographic material. The oil diffusion pumps disclosed herein may be coupled to the transmission microscope to provide a vacuum within the microscope.

In accordance with certain examples, the baffles disclosed herein may be used in an oil diffusion pump coupled to semiconductor processing devices and systems. Such devices include, but are not limited to, vapor deposition devices, e.g., vacuum deposition, physical vapor deposition, sputtering devices and the like. For example, the oil diffusion pump may be used to deposit thin film devices or to deposit protective or barrier coatings to prevent corrosion or to withstand harsh environments. In other examples, the oil diffusion pump may be used to provide a lowered pressure in a vacuum deposition chamber. For example, a material to be evaporated may be placed in the chamber. An electron beam may be incident on the material in the chamber, and the resulting heating from the electron beam evaporates the material. A substrate may be positioned within the chamber to receive the evaporated material. The distance between the substrate and the material may be adjusted using mechanical devices, such as a manipulator. The evaporated material may be deposited by condensation on the substrate, e.g., in the case of certain refractories such as alumina, zirconia, titania, etc., or the evaporated material may be carried by a reactive gas to the substrate. Co-evaporization processes may also be used. Additional vapor deposition processes and device suitable for use with the oil diffusion pumps disclosed herein will be readily selected by the person of ordinary skill in the art, given the benefit of this disclosure.

In certain examples, the oil diffusion pump may be used in other devices. For example, the oil diffusion pump may be used with devices and methods designed for crystal growth, such as molecular beam epitaxy. The oil diffusion pump may be used in freeze-drying apparatus. The oil diffusion pump may be used in electron microprobes. The oil diffusion pump may be used in other systems and devices where a vacuum is desirable.

In certain examples, additional features such as valves, cold traps and the like may be used with the oil diffusion pumps disclosed herein. The exact type of oil used in the oil diffusion pumps may vary and suitable oils include, but are not limited to, silicone based oils, Santovac® pump oils, Inland™ pump oils, Modoc™ pump oils and other suitable types of pump oils. The conditions used to operate the pump may be selected, at least in part, on the type of oil used, the desired pressure, the type of heating element and the like.

In accordance with certain examples, a method of retarding oil vapor loss in an oil diffusion pump is provided. In some examples, the method comprising configuring the pump with a baffle constructed and arranged with a plurality of apertures, with at least one of the apertures including a convergent portion and a divergent portion. In some examples, the baffle may be configured such that each aperture includes a convergent and a divergent portion.

In accordance with certain examples, a method of configuring a mass spectrometer is provided. In some examples, the method comprises mounting an oil diffusion pump proximate to a sample introduction device. As discussed above, the term proximate refers to mounting of the diffusion pump next to or adjacent to the sample introduction device. Existing diffusion pumps typically are not mounted proximate to the sample introduction device as the back-streaming of oil vapor interferes with the analysis. The method may further comprise configuring the oil diffusion pump with a baffle including at least one aperture comprising a convergent portion and a divergent portion. In some examples, the baffle may be constructed and arranged to retard loss of oil vapor from the oil diffusion pump.

Certain specific examples are described below to illustrate further the novel technology described herein.

### EXAMPLE 1

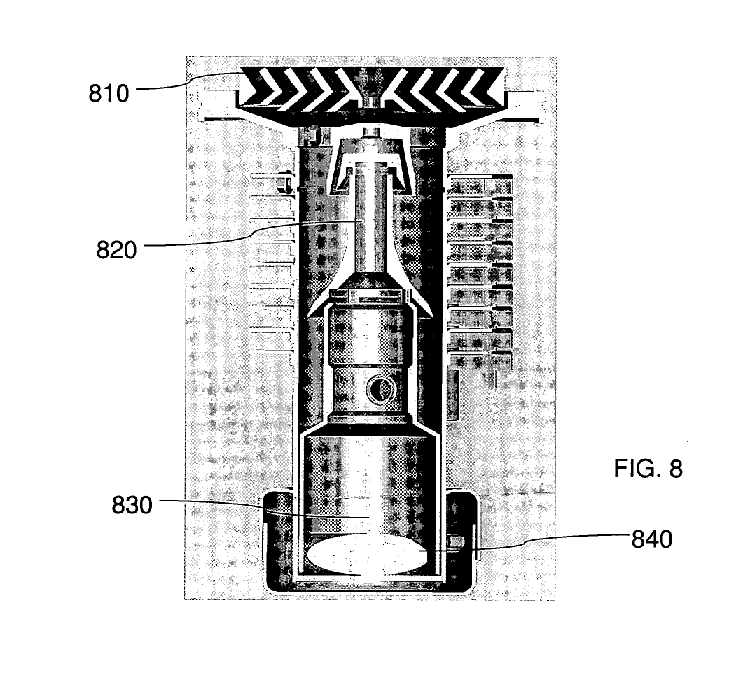

An oil diffusion pump was assembled as follows: An oil diffusion pump (Model No. EO50/60 from Edwards was modified by removing the heat shield and inserting a non-cooled symmetric, conical converging/diverging baffle into the pump mouth from above and within the vacuum chamber. The baffle was machined from a piece of an aluminum bar or plate. The baffle profile was made by turning with a lathe. The converging/diverging apertures were created by milling. The dimensions of the baffle were 3.9 inches in diameter and 0.66 inches thick. The baffle was held in place by gravity. A schematic of the assembled diffusion pump is shown in FIG. 8. The pump 800 included the non-cooled baffle 810, a jet assembly 820, a chamber 830 for receiving an oil, and a heating element 840.

### EXAMPLE 2

Testing of the oil diffusion pump of Example 1 was performed using a mass spectrometer (MS) coupled to a gas chromatograph (GC). The diffusion pump met the 1 picogram octafluoronaphthalene (OFN) 100:1 signal-to-noise standard when allowed to pump for a sufficient period of time, in a clean MS. A vacuum pressure of about 4×10⁻⁵ Torr was achieved for nominal operating conditions (GC column flow of 1 mL/min). No apparent oil background was present following 3-4 weeks of normal operation with samples. The pump tolerated up to 3-4 mL/min of carrier gas pressure-pulse when using splitless injections.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples may be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

What is claimed is:

1. An oil diffusion pump comprising:
a jet assembly comprising a plurality of nozzles;
a heating element;
a chamber configured to receive an oil and coupled to the heating element and the jet assembly; and
a non-cooled baffle fluidically coupled to the chamber and comprising a plurality of apertures, wherein at least one of the plurality of apertures comprises a convergent portion and a divergent portion.

2. The oil diffusion pump of claim 1, in which the non-cooled baffle is constructed and arranged with a symmetric number of apertures about a central axis of the baffle.

3. The oil diffusion pump of claim 1, in which the non-cooled baffle is constructed and arranged with asymmetric number of apertures about a central axis of the baffle.

4. The oil diffusion pump of claim 1, further comprising an additional pump fluidically coupled to the diffusion pump.

5. The oil diffusion pump of claim 1, in which the non-cooled baffle further comprises a circumferential ridge.

6. The oil diffusion pump of claim 1, in which the baffle includes at least two concentric cones and apertures are positioned between the at least two concentric cones.

7. The oil diffusion pump of claim 6, in which the baffle further comprises at least one rib connecting the concentric cones.

8. An oil diffusion pump comprising:
a jet assembly comprising a plurality of nozzles;
a heating element;
a chamber configured to receive an oil and coupled to the heating element and the jet assembly; and
a non-cooled baffle fluidically coupled to the chamber and comprising at least two concentric cones.

9. The oil diffusion pump of claim 8, in which the non-cooled baffle comprises two to five concentric cones.

10. The oil diffusion pump of claim 8, further comprising an additional pump fluidically coupled to the diffusion pump.

11. The oil diffusion pump of claim 8, in which the non-cooled baffle further comprises a circumferential ridge.

12. The oil diffusion pump of claim 8, in which the non-cooled baffle includes an aperture positioned between the at least two concentric cones.

13. A mass spectrometer comprising:
a mass analyzer;
a detector fluidically coupled to the mass analyzer;
an oil diffusion pump fluidically coupled to the mass analyzer and the detector and comprising
a jet assembly comprising a plurality of nozzles;
a heating element;
a chamber configured to receive an oil and coupled to the heating element and the jet assembly; and
a non-cooled baffle fluidically coupled to the chamber and comprising
a plurality of apertures, wherein at least one of the plurality of apertures comprises a convergent portion and a divergent portion.

14. The mass spectrometer of claim 1, in which the non-cooled baffle includes at least two concentric cones and apertures are positioned between the at least two concentric cones.

15. The mass spectrometer of claim 14, in which the non-cooled baffle further comprises at least one rib connecting the concentric cones.

16. The mass spectrometer of claim 13, further comprising a sample introduction device fluidically coupled to the mass analyzer.

17. The mass spectrometer of claim 16, further comprising a gas chromatography system fluidically coupled to the sample introduction device.

18. The mass spectrometer of claim 16, in which the oil diffusion pump is mounted proximate to the sample introduction device.

19. A mass spectrometer comprising:
a mass analyzer;
a detector fluidically coupled to the mass analyzer;
an oil diffusion pump fluidically coupled to the mass analyzer and the detector and comprising
a jet assembly comprising a plurality of nozzles;
a heating element;
a chamber configured to receive an oil and coupled to the heating element and the jet assembly; and
a non-cooled baffle fluidically coupled to the chamber and comprising at least two concentric cones.

20. The mass spectrometer of claim 19, in which the non-cooled baffle includes an aperture positioned between the at least two concentric cones.

21. The mass spectrometer of claim 20, in which the non-cooled baffle further comprises at least one rib connecting the concentric cones.

22. The mass spectrometer of claim 19, further comprising a sample introduction device fluidically coupled to the mass analyzer.

23. The mass spectrometer of claim 22, further comprising a gas chromatography system fluidically coupled to the sample introduction device.

24. The mass spectrometer of claim 19, in which the oil diffusion pump is mounted proximate to the sample introduction device.

25. A method of configuring a mass spectrometer comprising:
mounting an oil diffusion pump proximate to a sample introduction device; and
configuring the oil diffusion pump with a non-cooled baffle including at least one aperture comprising a convergent portion and a divergent portion, wherein the baffle is constructed and arranged to retard loss of oil vapor from the oil diffusion pump.
